(19) United States
(12) Patent Application Publication
(10) Pub. No.: US 2013/0064675 A1
(43) Pub. Date: Mar. 14, 2013

(54) WIND TURBINE ROTOR BLADE

(71) Applicant: Klaus-Peter Jaquemotte, Westerstede (DE)

(72) Inventor: Klaus-Peter Jaquemotte, Westerstede (DE)

(73) Assignee: WOBBEN PROPERTIES GMBH, Aurich (DE)

(21) Appl. No.: 13/583,622

(22) PCT Filed: Mar. 9, 2011
(86) PCT No.: PCT/EP11/53563

§ 371 Date: Nov. 27, 2012

(30) Foreign Application Priority Data
Mar. 10, 2010 (DE) 102010002720.0-15

(51) Int. Cl. F03D 1/06; B32B 1/04; B23P 15/04

(52) U.S. Cl. 416/226; 416/229 R; 29/889.71; 264/258

(57) ABSTRACT

The invention concerns a wind power installation rotor blade. The rotor blade has a rotor blade root, a rotor blade tip, a rotor blade leading edge and a rotor blade trailing edge. The rotor blade further has a pressure side and a suction side as well as at least one web at least partially between the suction and pressure sides. The rotor blade has a longitudinal direction between the rotor blade root and the rotor blade tip. The web is of a wave-shaped configuration in the longitudinal direction of the rotor blade.

### BACKGROUND

1. Technical Field

The present invention concerns a wind power installation rotor blade.

2. Description of the Related Art

DE 103 36 461 describes a wind power installation rotor blade, wherein spars of composite fiber materials are provided in a rotor blade in the longitudinal direction. Those spars can be made for example from glass fiber-reinforced fibers, for example by impregnation in a resin. The spars are typically provided both at the suction side of the rotor blade and also at the pressure side. The spares can be produced beforehand and then fitted into the rotor blades or half-shell portions. That has the advantage that the spars can be produced beforehand under constant conditions. In particular that is intended to avoid the spars becoming wavy during production. Waviness of the spars is unwanted because the spars serve to carry loads. Thus it is necessary to provide quality assurance to prevent the spars becoming wavy or undulating.

The general state of the art attention is shown in DE 10 2008 022 548 A1 and DE 203 20 714 U1.

### BRIEF SUMMARY

One object of the present invention is to provide a wind power installation rotor blade which permits inexpensive manufacture.

That object is attained by a wind power installation rotor blade according to claim 1.

Thus there is provided a wind power installation rotor blade. The rotor blade has a rotor blade root, a rotor blade tip, a rotor blade leading edge and a rotor blade trailing edge. The rotor blade further has a pressure side and a suction side as well as at least one web at least partially between the suction and pressure sides. The rotor blade has a longitudinal direction between the rotor blade root and the rotor blade tip. The web is of a wave-shaped configuration in the longitudinal direction of the rotor blade.

In an aspect of the present invention the rotor blade has spars at the pressure side and at the suction side. The at least one web is fixed in the region of the spars.

In a further aspect of the present invention the web is produced by hot shaping of fiber-reinforced thermoplastic materials.

In a further aspect of the present invention the wave shape of the web is of a sinusoidal configuration.

In a further aspect of the present invention there are provided at least two substantially mutually parallel webs.

The invention also concerns a use of webs of a wave-shaped configuration in the production of a wind power installation rotor blade.

The invention also concerns a wind power installation having at least one rotor blade as described hereinbefore.

The invention is based on the concept of providing a wind power installation rotor blade having webs between the pressure side and the suction side of the rotor blade. The webs are not straight in longitudinal section, but are of a wave-shaped or undulating configuration.

Thus there is provided a wavy or undulating or a sinusoidally wavy web or spar web. The spar web can be produced for example from fiber-reinforced thermoplastic materials so that an automatic production line can be implemented for example by hot shaping of the fiber-reinforced thermoplastic materials. Preferably the fiber-reinforced thermoplastic materials are unwound from a roll.

Preferably the webs are produced by machine from thermoplastic material. As an alternative thereto the webs can be produced from pre-preps with subsequent UV hardening.

The webs serve to increase the strength of the rotor blade. For that purpose the webs can be provided between the suction and pressure sides of the rotor blade. The webs can be fixed or glued for example to the spars provided along the pressure side and the suction side. Those webs serve only for providing strength, but not for carrying away the load within the rotor blade.

Further configurations of the invention are subject-matter of the appendant claims.

### BRIEF DESCRIPTION OF THE SEVERAL VIEWS OF THE DRAWING(S)

Advantages and embodiments by way of example of the invention are described in greater detail hereinafter with reference to the drawing.

FIG. 1 shows a diagrammatic view of a wind power installation according to the invention,

FIG. 2 shows a cross-section of a wind power installation rotor blade for the wind power installation of FIG. 1, and

FIG. 3 shows a longitudinal section of a wind power installation rotor blade for the wind power installation of FIG. 1

### DETAILED DESCRIPTION

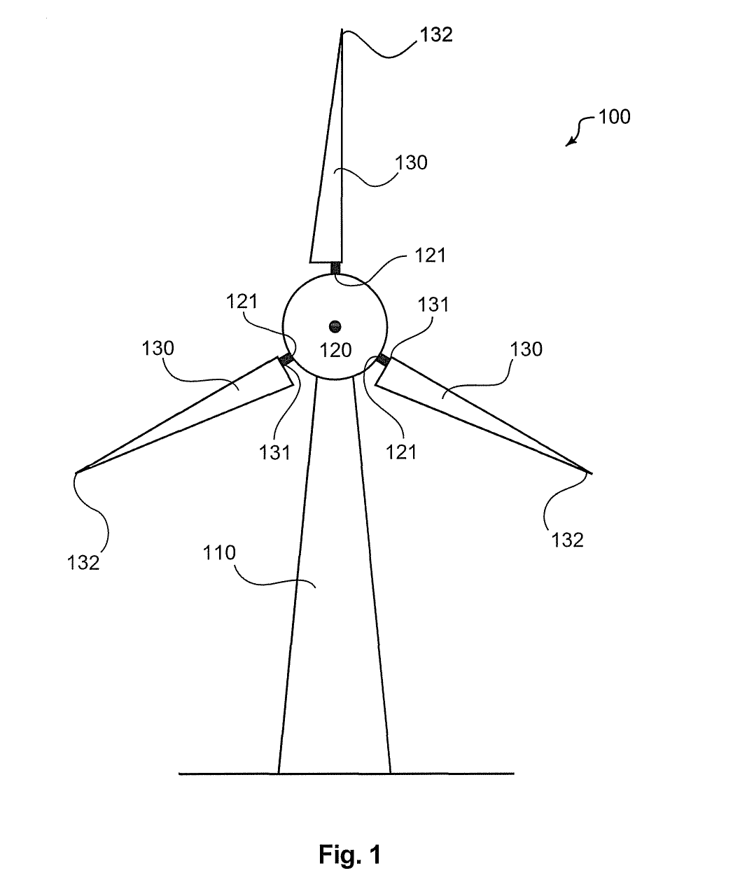

FIG. 1 shows a diagrammatic view of a wind power installation according to the invention. The wind power installation 100 has a pylon 110 with a pod 120 at the upper end of the pylon 110. For example three rotor blades 130 are arranged on the pod 120. The rotor blades 130 have a rotor blade tip 132 and a rotor blade root 131. The rotor blades 130 are fixed at the rotor blade root 131 for example to the rotor hub 121. The pitch angle of the rotor blades 130 is preferably controllable in accordance with the currently prevailing wind speed.

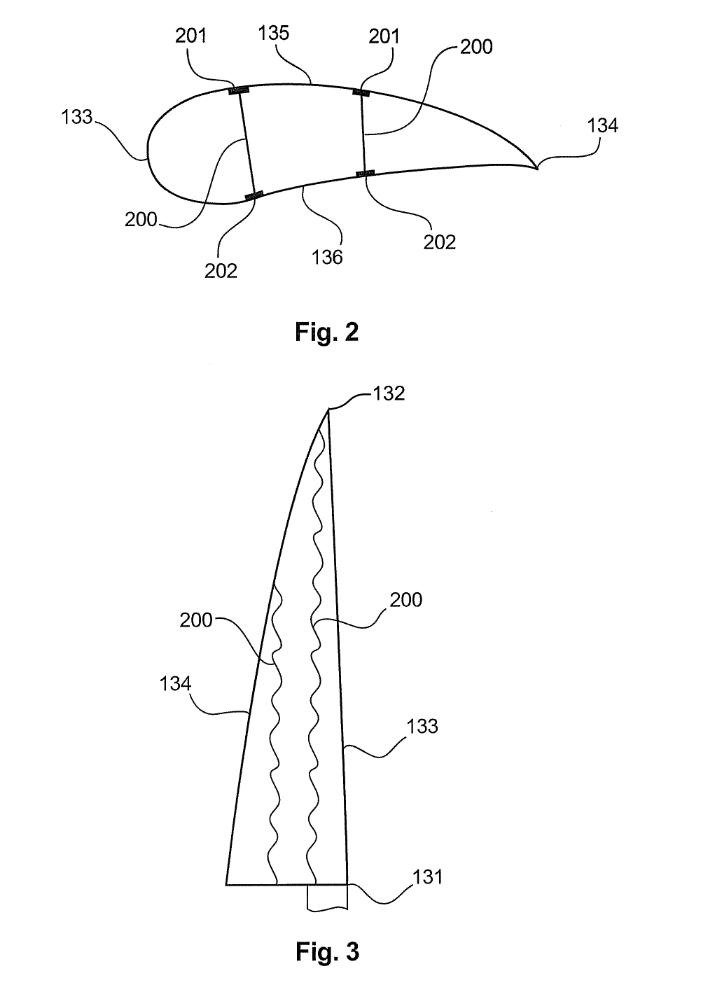

FIG. 2 shows a cross-section of a wind power installation rotor blade according to a first embodiment. As shown in FIG. 1 the rotor blade 130 has rotor blade tip 132 and a rotor blade root 131. The rotor blade 130 also has a leading edge 133 and a trailing edge 134. Furthermore the rotor blade 130 has a suction side 135 and a pressure side 136. Webs 200 can be provided between the pressure and the suction sides 136, 135 at least partially along the length of the rotor blade (between the rotor blade root and rotor blade tip 131, 132). The webs have a first end that connects to a first spar 201 and a second end that connects to a different spar 202. The first spar 201 is fixed to the suction side 135 and the second spar 202 is fixed to the pressure side 136. In other words the webs are mechanically connected to the suction side and the pressure side. The webs 200 are preferably provided to improve the mechanical stability of the rotor blades. The webs can be provided continuously or at least partially along the length or the longitudinal direction of the rotor blade between the rotor blade root 131 and the rotor blade tip 132.

In the first embodiment the webs 200 are of an undulating configuration, a wave-shaped configuration or a sinusoidal configuration, along the longitudinal direction. Alternatively thereto the webs 200 can also be in the form of a sawtooth or a triangular undulation along the longitudinal direction.

The webs can serve to transmit a part of the lift force from the pressure side to the suction side. The webs can thus transmit forces perpendicularly to their longitudinal direction, that is to say from the pressure side of the rotor blade to the suction side. The webs however are less suited to transmitting forces in the longitudinal direction thereof.

FIG. 3 shows a longitudinal section of a wind power installation rotor blade for the wind power installation of FIG. 1. The rotor blade has a rotor blade root 131, a rotor blade tip 132, a rotor blade leading edge 133 and a rotor blade trailing edge 134. In addition webs 200 extend between the pressure side and the suction side of the rotor blade (as shown in FIG. 2). Those webs 200 are of a wave-shape, undulating or sinusoidal configuration along the longitudinal direction of the rotor blade. Alternatively thereto the webs 200 can also be in the form of a sawtooth or a triangular undulation.

The webs shown in FIGS. 2 and 3 can be made by machine for example from a thermoplastic material. That can be effected for example by hot shaping of fiber-reinforced thermoplastic materials.

The webs can be produced in particular from rolled-up fiber-reinforced thermoplastic materials, in which case the wave shape can be produced by the hot shaping operation.

A saving in material of between 10% and 20% (in particular 15%) can be achieved by those webs of a wave-shaped configuration. As the webs are of a wave-shaped or undulating configuration in the longitudinal direction they do not contribute to carrying load so that the load is still carried away as previously by way of fiber-reinforced spars provided at the pressure and suction sides. On the other hand a lift force caused by the wind can be transmitted for example in a proportion of 90% by way of the webs 200.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind power installation rotor blade comprising
a rotor blade root, a rotor blade tip, a rotor blade leading edge and a rotor blade trailing edge,
a pressure side and a suction side, and
at least one web at least partially between the suction and pressure sides, the web having a wave-shaped configuration of the web in a longitudinal direction of the rotor blade,
wherein the longitudinal direction of the rotor blade extends between the rotor blade root and the rotor blade tip,

2. The rotor blade according to claim 1 further comprising spars at the pressure side and/or the suction side, wherein the at least one web is fixed in the region of the spars.

3. The rotor blade according to claim 1 characterized by a web produced by hot shaping of fiber-reinforced thermoplastic materials.

4. The rotor blade according to claim 1 characterized by a sinusoidal configuration for the wave shape of the web.

5. The rotor blade according to claim 1 characterized by at least two substantially mutually parallel webs.

6. The rotor according to claim 1, comprising use of webs of a wave-shaped configuration in the production of a wind power installation rotor blade.

7. A wind power installation having at least one rotor blade according to claim 1.

8. A process for the production of a wind power installation rotor blade which has a rotor blade root, a rotor blade tip, a rotor blade leading edge, a rotor blade trailing edge, a pressure side and a suction side, comprising:
providing a web of a wave-shaped configuration in the longitudinal direction of the rotor blade.

9. The process according to claim 8 wherein the at least one web is produced by hot shaping of fiber-reinforced thermoplastic materials.

10. A wind power installation rotor blade comprising:
a first side;
a second side; and
at least one web between the first side and the second side, the web having an undulating configuration at least partially along a longitudinal direction of the rotor blade from a rotor blade root to a rotor blade tip.

11. The rotor blade according to claim 10,
wherein the undulating configuration is a wave-shaped configuration.

12. The rotor blade according to claim 10,
wherein the undulating configuration is a sinusoidal configuration.

13. The rotor blade according to claim 10,
wherein the undulating configuration is a sawtooth configuration.

14. The rotor blade according to claim 10,
wherein the undulating configuration is a triangular undulation configuration.

15. The rotor blade according to claim 10, further comprising:
a spar at the first side; and
the at least one web is fixed to the spar.

16. The rotor blade according to claim 10, further comprising:
a spar at the second side; and
the at least one web is fixed to the spar.

17. The rotor blade according to claim 10,
wherein the at least one web is produced by hot shaping of fiber-reinforced thermoplastic materials.

18. The rotor blade according to claim 10,
wherein the at least one web is at least two substantially mutually parallel webs.
